(19) United States
(12) Patent Application Publication
(10) Pub. No.: US 2004/0073494 A1
(43) Pub. Date: Apr. 15, 2004

(54) Commercial transaction system

(76) Inventor: Kevin Cox, Acton Act (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/415,270

(22) PCT Filed: Oct. 29, 2001
(86) PCT No.: PCT/AU01/01376

(30) Foreign Application Priority Data
Oct. 27, 2000 (AU) PR 1077
May 23, 2001 (AU) 4801/01
May 23, 2001 (AU) 4803/01
May 23, 2001 (AU) 4804/01
May 23, 2001 (AU) 4805/01

(51) Int. Cl. G06F 17/60

(52) U.S. Cl. 705/26

(57) ABSTRACT

A real-time transaction system to which a plurality of parties can subscribe; said system including a persistent store which contains a record of any given transaction between two or more of said parties; said record being a shared record of said transaction.

The present invention relates to a commercial transaction system and, more particularly, to such a system suited for implementation across a network of computers of the type currently known as the Internet.

### BACKGROUND

Accounting systems currently operate on the basis of duplication. In a typical commercial transaction one party can usually be categorized as a “buyer” and the other party to the transaction can usually be categorized as a “seller”. A commercial transaction typically will involve, initially, the placement of an order for the supply of goods or services followed by a bill or invoice which is supplied with the goods/services when they are supplied. The invoice is followed, according to credit terms, by payment or settlement of the transaction.

The buyer will monitor the fact that an order has been placed, will subsequently monitor the receipt of a bill or invoice and will ultimately record the payment or settlement of the transaction. Commonly this information will be stored by the buyer in a database in the form of an accounting package.

From the other side of the transaction the seller will record receipt of an order, will record its dispatch of a bill/invoice and will subsequently monitor and note receipt of payment/settlement. The seller will record this data in its database, which is also commonly of the form of an accounting package.

In theory the accounting package of the buyer will contain data in relation to the transaction which is a duplicate of the data contained in the accounting package of the seller for the same transaction. A checking arrangement in the form of a monthly statement or other summary of obligations incurred/payments received is often employed by both parties with a view to reconciling the data representing the transaction on the database of each party.

It can be observed that the duplication of record keeping thus described and which is characteristic of account record keeping employed by most organizations today is wasteful of resources, both human and computer.

Such systems tend to have relatively high costs per transaction recorded irrespective of the size or value of the transaction being recorded. Where the transaction involves, for example, micro payments (very small payments which can be on the order of fractions of a cent) the overhead of recording such transactions is disproportionately high.

It is an object of the present invention to overcome or ameliorate one or more of the abovementioned disadvantages.

### BRIEF DESCRIPTION OF INVENTION

Definitions

In this specification “real time” refers to a system wherein interactions with the system by a user are perceived by the user to take effect instantaneously or within a very short time interval, typically in the 1-3 second range.

In this specification the term “persistent” refers to the characteristic of stored data to be retained in a consistent state representing data either before the start of a transaction or at the completion of a transaction and no other in between or indeterminate state.

In this specification “transaction” refers to an end result of a commercial interaction between at least a first and a second user. Where commodities are the subject of a commercial transaction the term “transaction” refers to a finalized or concluded trade in a specified commodity. In particular examples the commodities traded can be goods, services, shares, futures, commodities and the like.

Transactions are stored according to ACID principles. That is to say, the transaction has the characteristics of being atomic, consistent, isolated and durable (or persistent). In this instance each transaction is itself made up of a discrete number of steps, and each step itself is a transaction in itself.

Each transaction, in addition, has the characteristics of being secure, non-repudiatable, authenticated and persistent.

In this specification “definitive” in the context of a “definitive record” of a transaction describes a transaction which is agreed as legally binding and irrefutable by the users who are parties to that transaction. It would be expected that a “definitive record” would be sufficient evidence of a transaction to satisfy authorities such as tax authorities in the jurisdictions of interest in the transaction.

Accordingly, in one broad form of the invention there is provided a real-time transaction system to which a plurality of parties can subscribe; said system including a persistent store which contains a record of any given transaction between two or more of said parties; said record being a shared record between said two or more of said parties of said transaction.

Preferably said shared record, by agreement of those of said parties who are subscribers to said system, is a definitive record of said transaction.

Preferably said transaction entails a purchase.

Preferably said transaction entails a sale.

Preferably said transaction comprises an ACID transaction.

Preferably each of said parties is characterized by a transaction.

Preferably a party is characterized by said transaction based on their role of said transaction.

Preferably a party is characterized as a buyer when the role of said party is as a buyer.

Preferably a party is characterized as a seller when the role of said party is as a seller.

Preferably said record is protected by a security regime.

Preferably said security regime is determined by a user of said system.

Preferably each said security level is set by reference to the nature of a connection established by an individual one of said parties for and only for a particular transaction.

Preferably said shared record can be accessed by each of said parties.

Preferably said party has access to only a part of said shared record.

Preferably said record to which a party has access is determined by the capacity in which said party acted in respect of data contained in said record.

In a further broad form of the invention there is provided a commercial transaction system to which a plurality of users can subscribe; said users agreeing to adopt a single common record as a definitive record of any given transaction between two or more of said users.

In yet a further broad form of the invention there is provided a method of determining security levels for parties to a transaction system; said transaction system being of the type to which a plurality of said parties can subscribe; said method comprising setting one or more security levels for an activity based on information derived from said party.

In yet a further broad form of the invention there is provided a real-time transaction system to which a plurality of parties can subscribe; said system including a persistent store which contains a single record of each and every transaction between two or more of said parties; said record being a shared record of said transaction.

Preferably said shared record, by agreement of those of said parties who are subscribers to said system, is a definitive record of said transaction between any said users so transacting.

Preferably said shared record can be accessed by each of said parties.

Preferably each said party has access to only a part of said shared record.

Preferably said record to which a party has access is determined by the capacity in which said party acted in respect of data contained in said record.

Preferably each said transaction comprises a plurality of steps; said system integrating said plurality of steps.

Preferably said plurality of steps includes steps selected from deposit taking, ordering, billing and payment.

Preferably each step of said transaction comprises an ACID transaction.

Preferably each step of said transaction is Secure, Non-repudiable, Authenticated and Persistent.

Preferably said parties conclude said steps of said transactions by interacting directly with said record of said transaction; and wherein said interacting does not require said parties to cause the transmission of data to other parties.

Preferably said transaction entails a purchase.

Preferably said transaction entails a sale.

Preferably the role of each of said parties in any given said transaction is determined by their action within said transaction.

Preferably said role of said party in any given said transaction is characterized as a buyer when said party acts as a buyer in said transaction.

Preferably said role of said party in any given said transaction is characterized as a seller when said party acts as a seller.

In a further broad form of the invention there is provided a real-time transaction system to which a plurality of parties can subscribe; said system including a persistent store which contains a record of any given transaction between two or more of said parties; each of said parties being characterized by said system based on their role in said any given transaction.

In yet a further broad form of the invention there isi provided a commercial transaction system to which a plurality of users can subscribe; said users agreeing to adopt a single common record as a definitive record of any given transaction between two or more of said users.

In yet a further broad form of the invention there is provided a real-time transaction system to which a plurality of parties can subscribe; said system including a persistent store which contains a single record of each and every transaction between two or more of said parties; said record being a shared record of said transaction.

In yet a further broad form of the invention there is provided a method of determining security levels for parties to a transaction system; said transaction system being of the type to which a plurality of said parties can subscribe; said method comprising setting one or more security levels for an activity based on information derived from said party.

In yet a further broad form of the invention there is provided a real-time transaction system to which a plurality of parties can subscribe; said system incorporating the method of claim 64; said system including a persistent store which contains a record of any given transaction between two or more of said parties; said record being a shared record of said transaction.

In yet a further broad form of the invention there is provided a method of determining levels of authentication for parties to a transaction system; said transaction system being of the type to which a plurality of said parties can subscribe; said method comprising setting one or more security levels for an activity based on information derived from said party.

In yet a further broad form of the invention there is provided a real-time transaction system to which a plurality of parties can subscribe; said system including a persistent store which contains a record of any given transaction between two or more of said parties; said record being a shared record of said transaction; said transaction comprising a plurality of steps; said system integrating said plurality of steps.

In yet a further broad form of the invention there is provided a real-time transaction system to which a plurality of parties can subscribe; said system including a persistent store which contains a single record of each and every given transaction between two or more of said parties; said record being a shared record of said transaction.

### BRIEF DESCRIPTION OF DRAWINGS

Embodiments of the present invention will now be described with reference to the accompanying drawings wherein:

FIG. 1 is a block diagram of a commercial transaction system according to a first embodiment of the present invention;

FIG. 2 is a block diagram of a commercial transaction system in accordance with a second preferred embodiment of the present invention;

FIG. 3 is a block diagram of a form of implementation of the system of FIG. 2;

FIG. 4 is a block diagram of a database implementation of the transaction record of the commercial transaction system of any one of FIGS. 1, 2 or 3;

FIG. 5 is an interconnection diagram for the implementation of FIG. 4;

FIGS. 6A, 6B is a detailed interconnection diagram of an implementation based on the system of FIG. 4;

FIG. 7 is a block diagram of an interaction between two users of the system of any one of FIGS. 1 to 4;

FIG. 8 is a block diagram of a unitary store structure which implements the persistent store of FIG. 7;

FIG. 9 is a screen interface to the unitary store of FIG. 8;

FIG. 10 is a screen interface of a customer statement summary for the system of FIG. 9;

FIG. 11 is a vendor statement summary for the system of FIG. 9;

FIG. 12 is a screen interface to a web shopping service for the system of FIG. 9;

FIG. 13 is a block diagram of a commercial transaction system according to a further embodiment of the present invention wherein each step comprises an ACID transaction;

FIG. 14 is a block diagram of the system of FIG. 13 and illustrating its relationship with a persistent store and deposit holders;

FIG. 15 is a block diagram of the relationship between an account holder and a deposit holder with reference to the persistent store of FIG. 14;

FIG. 16 is a flow diagram of a user defined levels of trust selection system; and

FIG. 17 is a conceptual view of the system of FIG. 1.

### DETAILED DESCRIPTION OF PREFERRED EMBODIMENTS

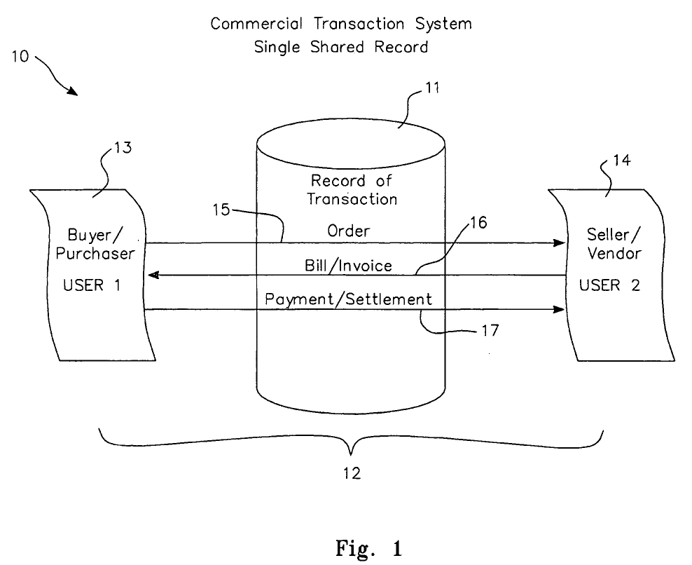

With reference, initially, to FIG. 1 there is illustrated a block diagram of a commercial transaction system 10 according to a first preferred embodiment of the present invention.

The system 10, in this instance, comprises a transaction record 11 which records information associated with a transaction 12 occurring between a first user 13 of the system 10 and a second user 14 of the system 10.

In this instance first user 13 is acting as a buyer/purchaser of goods/services in transaction 12. In this instance second user 14 is acting as a seller/vendor of goods/services in the transaction 12.

The transaction comprises the placement of an order 15 by first user 13 on second user 14. At the time of supply of the goods/services (not shown) the second user 14 issues a bill or invoice 16 upon first user 13.

Subsequently first user 13 pays or settles invoice 16 by means of payment 17 in favour of second user 14.

Hence, transaction 12 is made up of order 15, bill 16 and payment 17 and, in this instance, information pertaining to order 15, bill 16 and payment 17 is recorded in transaction record 11.

It is to be understood that whilst the entire transaction is made up of steps 15, 16, 17, each of the steps comprising order 15, bill 16 and payment 17 is independent of any other of the steps 15, 16, 17 and are each stored independently in transaction record 11 in a persistent manner. In this instance each step 15, 16, 17 is also stored in ACID form.

Transaction record 11 is set up as a shared record to which both first user 13 and second user 14 have access.

In this instance, by the agreement of first user 13 and second user 14 as subscribers to commercial transaction system 10, the shared transaction record 11 is a definitive record of the transaction 12. The arrangement is such that there is no need from a commercial point of view for first user 13 or second user 14 to keep separate records of transaction 12.

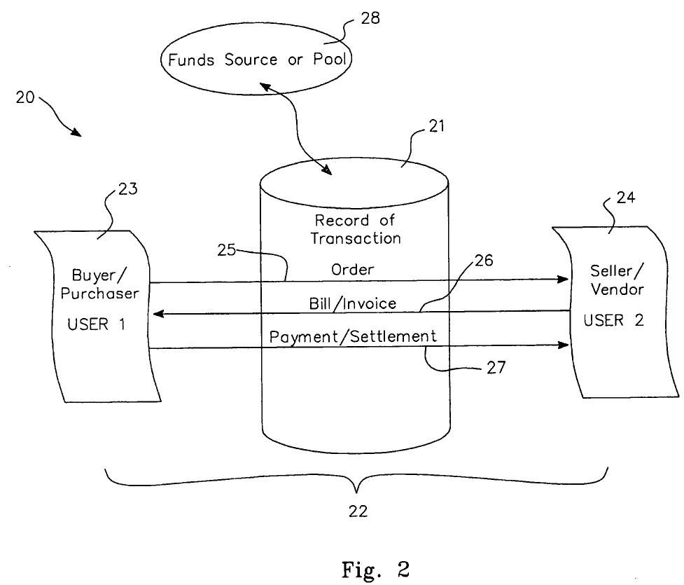

FIG. 2 illustrates a second embodiment of a commercial transaction system 20.

In this instance, and as for the arrangement of FIG. 1, a transaction 22 between first user 23 and second user 24 comprises placement of an order 25 by first user 23 on second user 24 followed by the issue of an invoice 26 followed by payment 27 all of which are stored in transaction record 21.

In this instance payment 27 is effected by way of a funds source or pool 28 which is associated with and in electronic communication with transaction record 21.

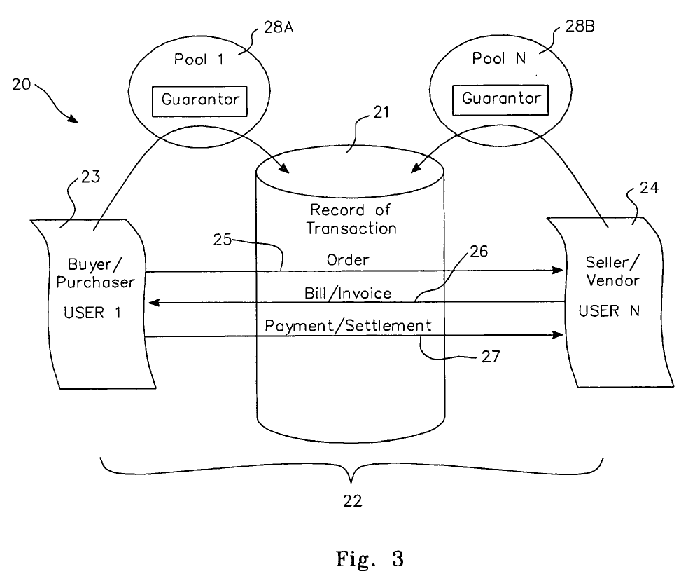

With reference to FIG. 3 the pool 28 can take many forms including, in this instance, a debit facility 28A which can be subdivided by first user 23 into, for instance, one or more pools for account keeping purposed, and, similarly a second pool 28B in the form of a debit facility associated with second user 24. Like components of the system 20 are otherwise numbered as for the arrangement of FIG. 2.

As will be appreciated the systems thus far described, namely systems 10, 20 can be comprised of any number of users, hence the designation user 1 for first user 13, 23 and the designation user N for second user 14, 24 wherein N can be any integer value.

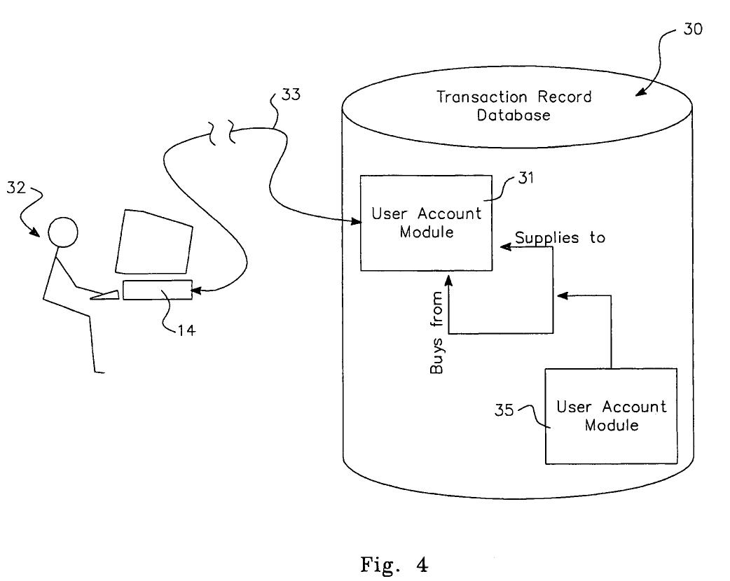

FIG. 4 is a block diagram of an implementation as a transaction record database or persistent store 30. The persistent store 30 can be implemented on a computer, for example a server computer (not shown) to which users may gain access via a computer network such as, for example, the international network of computers currently known as the Internet.

In this instance the commercial transaction system 10, 20 as described with reference to earlier embodiments, is implemented, in its most basic form as a plurality of software modules within persistent store 30. In this instance the persistent store 30 comprises a user account module 31 for a first user 32. The user 32 can access the user account module 31 by means of a connection 33 which may, for example, be implemented as a network connection via a personal computer 34 operated by user 32 and which is in communication via an Internet Service Provider (not shown) over the Internet to a computer (not shown) which houses and runs software associated with transaction record persistent store 30 including user account module 31. In alternative forms connection 33 could be a direct dial up connection implemented over wire, radio, opto-electrical, satellite or other data communications link.

Associated with user account module 31 is statement account module 35.

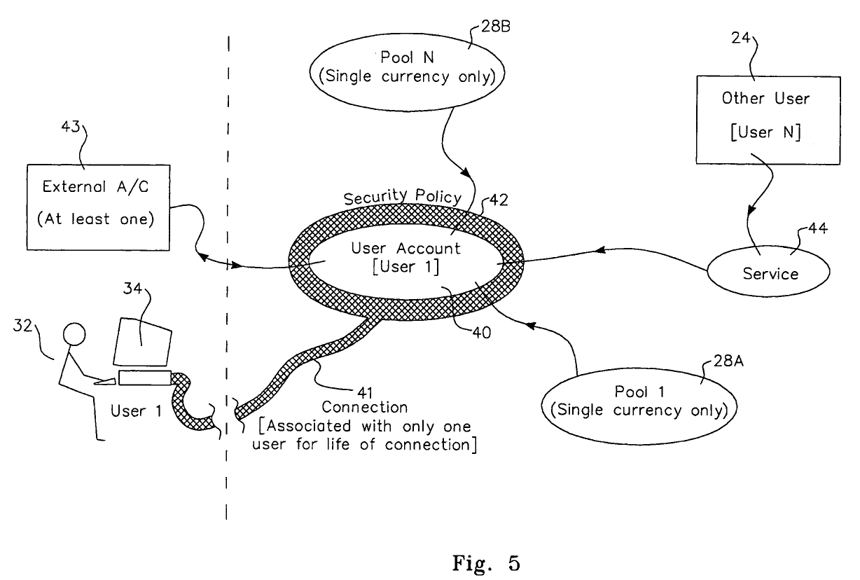

FIG. 5 is a more detailed block diagram of the system of FIG. 4 and its manner of interaction with another user designated user N (or second user 24) together with a first pool 28A associated with first user 32 and together with a second pool 28B (designated pool N) also associated with first user 32.

In the instance of FIG. 5 first user 32 is connected via PC 34 to his/her user account 40 by means of a connection 41. The arrangement is such that the connection can be associated with only one user account for the life of the connection.

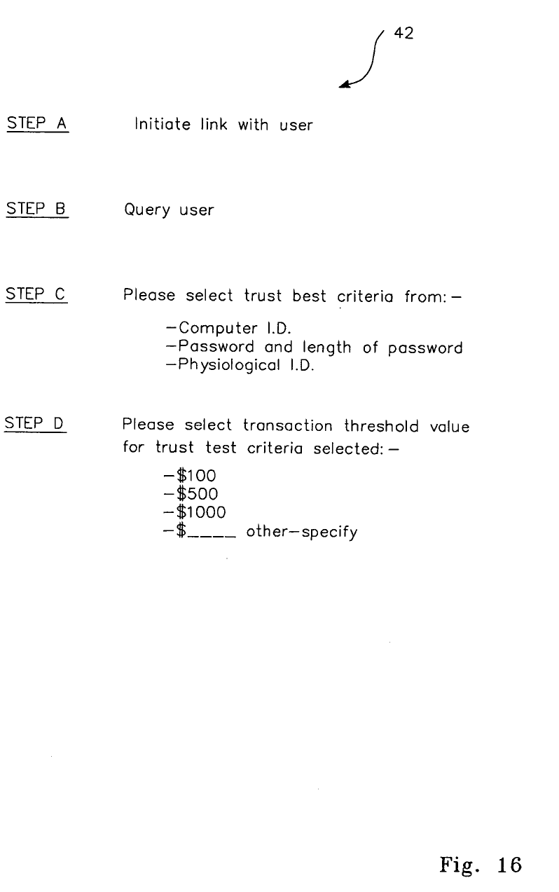

The user account 40 is protected by a security policy 42, one example of an implementation of which is given elsewhere with reference to FIG. 16.

The user account 40 allows first user 32 to interact with at least one external account 43, first pool 28A, second pool 28B and to be associated with a first service 44 to which second user 24 subscribes.

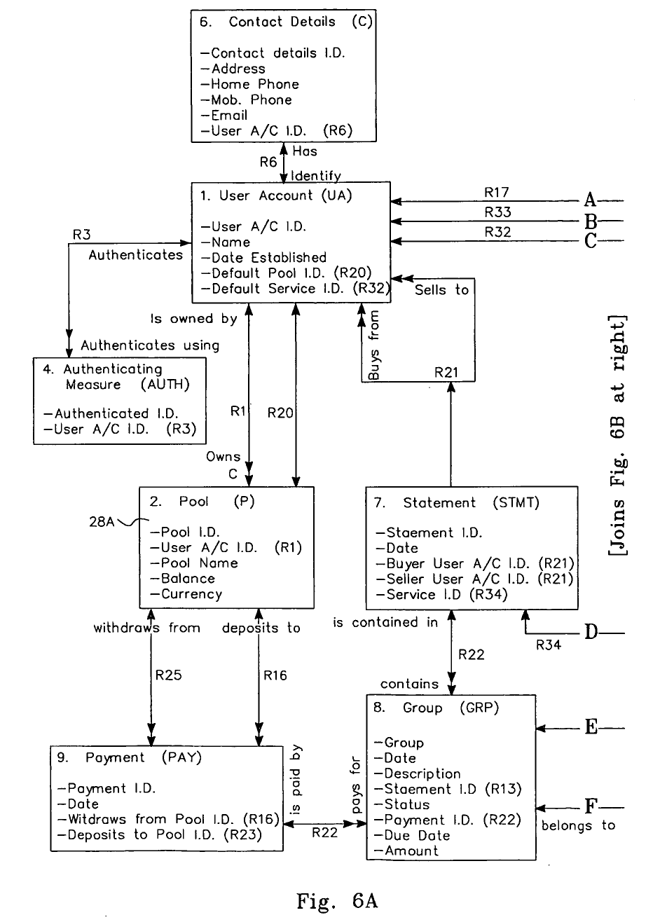

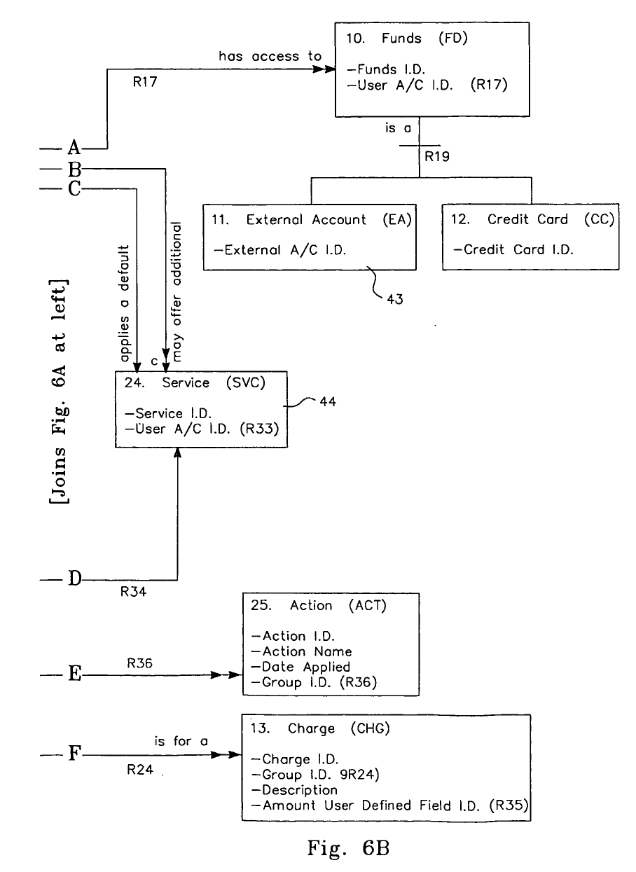

FIGS. 6A, 6B comprise an interconnected block diagram of the modules of a software implementation of the arrangement of FIG. 5 and wherein there is at least one external account 43 and wherein modules are otherwise numbered as for the components of FIG. 5 where specific modules correspond to the arrangements of FIG. 5.

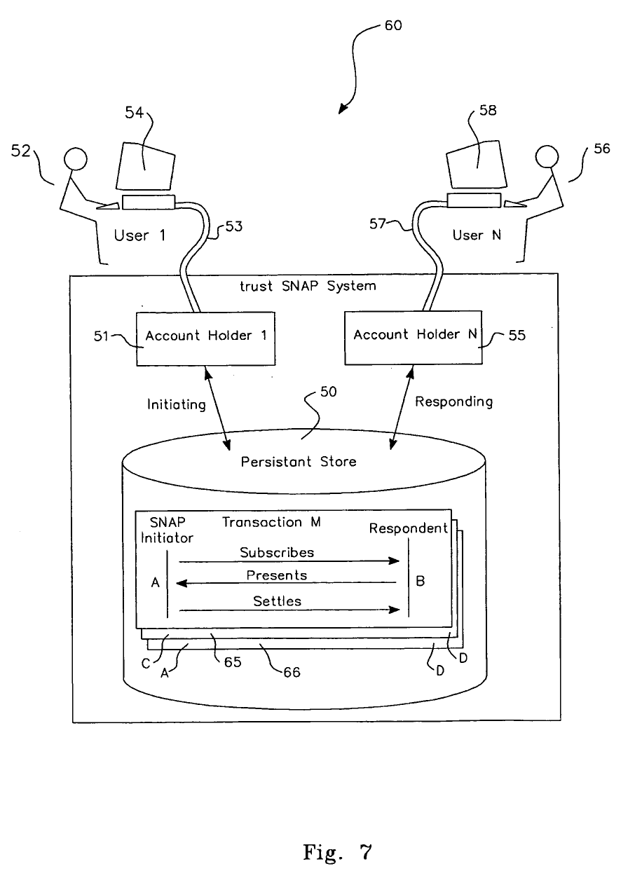

With reference to FIG. 7 there is illustrated a block diagram of a simpler system implemented in accordance with the arrangement of FIG. 1 and wherein the transaction environment occurs within a unitary store, in this instance in the form of a persistent store 50.

The persistent store 50 is accessible to first user account 51 of first user 52 via first connection 53 and first personal computer 54 or other Internet or network access device.

The persistent store 50 is also accessible to second user account 55 operated by second user 56 via second connection 57 and second personal computer 58 (or other Internet or network access device).

The persistent store 50 comprises a single store of all transactions into which a commercial transaction system 60 enters into according to a further embodiment of the invention.

In this instance a transaction M is made up of first step 61 comprising a subscription step; a second step 62 comprising a presentation step and a third step 63 comprising a settlement step. In this instance each step is itself an ACID transaction. In addition the data transfer comprising each step will have the following characteristics:

1. The transfer will be secure;

2. The information represented by the data cannot be repudiated;

3. The data transfer is authenticated; and

4. The data and each change to the data will be retained in a persistent manner within persistent store 50.

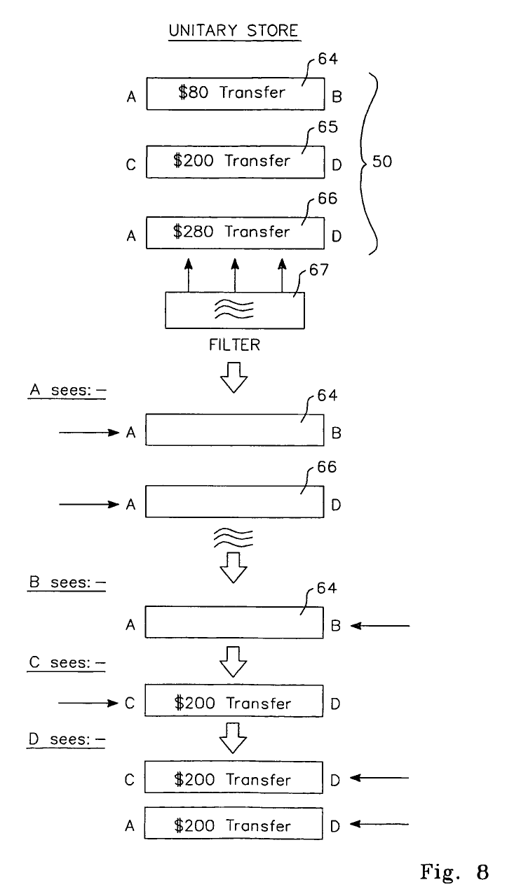

With reference to FIG. 8 the unitary store in the form of persistent store 50 contains the record of each and every transaction entered into by all users and account holders, in this instance represented by an example of three separate interactions and comprising, in this instance, first interaction 64 entailing a transfer of $80 between a user designated A and a user designated B; a second interaction 65 comprising the transfer of $200 from a user C to a user D; and a third interaction 66 comprising a transfer of $280 from user A to user D.

All of these interactions are stored in the unitary store comprising persistent store 50. However, access to the data comprising the interactions is restricted by filter means 67 by which any given user having access to the system is allowed to “see” only that data or portions of data to which they are entitled, for example by virtue of being a party to the relevant transaction.

So, in this instance, user A can “see” data relating to first interaction 64 and data relating to third interaction 66 because user A was a party to both of these interactions. User B can “see” only first interaction 64 because user B was a party only to this interaction. Similar filtering occurs, as illustrated for users C and D.

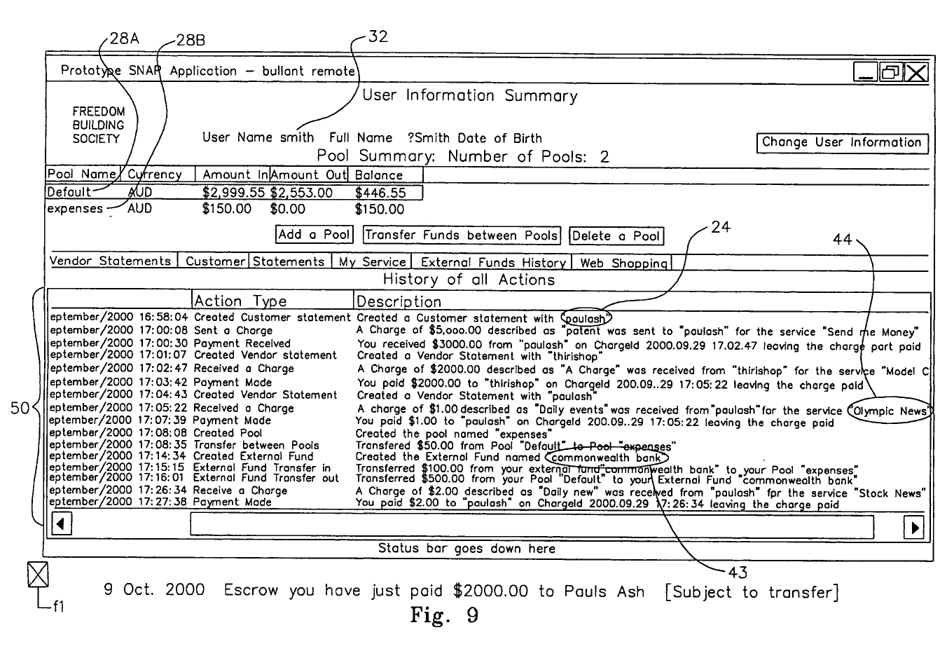

FIGS. 9 to 12 illustrate screen images of an Internet based implementation of the system of FIG. 7 wherein user 1 has user name “Smith” and user N has a user name “Paulash”. In this instance user 1 has access to two pools, the first one entitled “default” and the second entitled “expenses”. In this instance components are numbered where they correspond with the components of FIG. 5 but otherwise utilizing the persistent store 50 of FIGS. 7 and 8.

Accounts can be segregated into “pools” and other accounting practices can be applied.

FIG. 9 shows the details from persistent store 50 to which first user 32 (user name “Smith”) has access to as user A. User B entitled, in this instance, “Paulash” will have access to some of the data contained in this listing by virtue of his also being a party to at least some of the actions reflected in the history of all actions listed in FIG. 9.

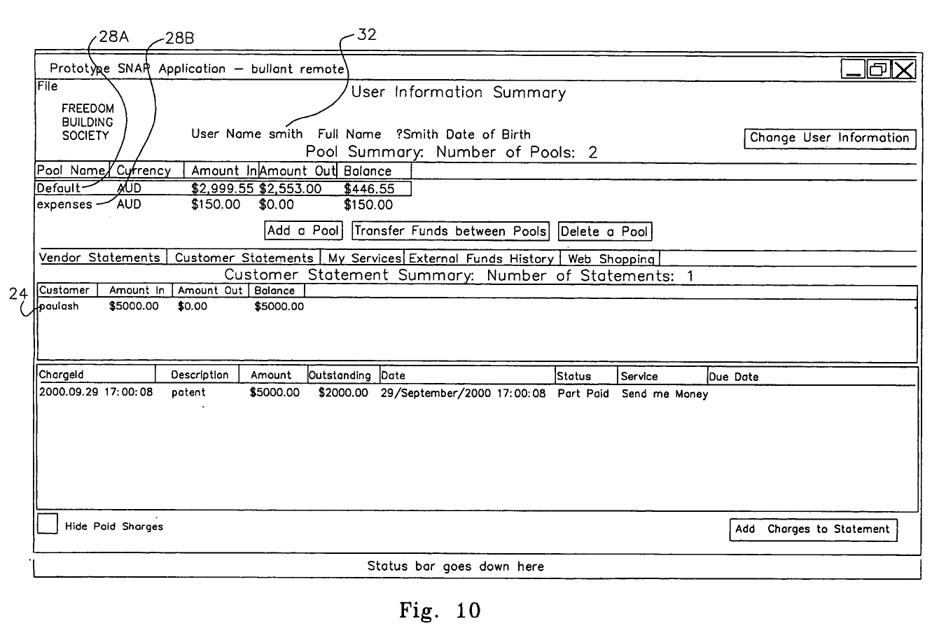

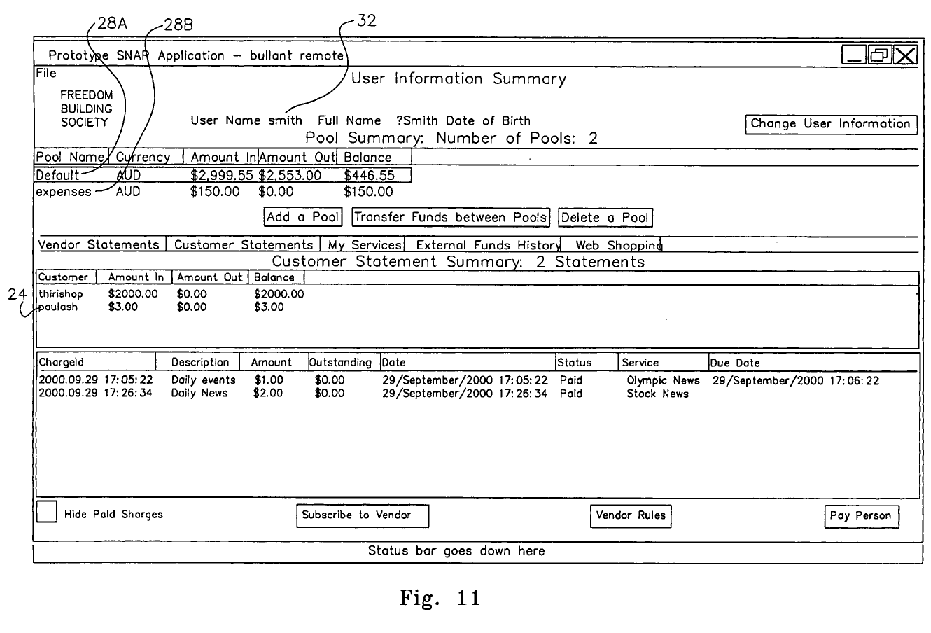

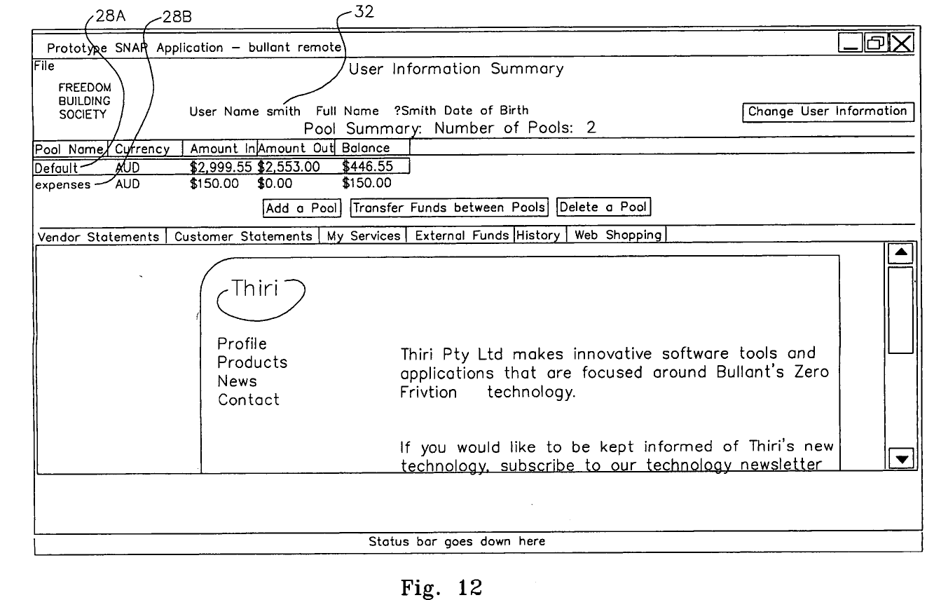

FIG. 10 provides a listing of customer statements. FIG. 11 provides a listing of vendor statements. FIG. 12 illustrates a manner of interaction with vendor “Thirishop” via a browser page interaction over the Internet.

Transaction Guarantor

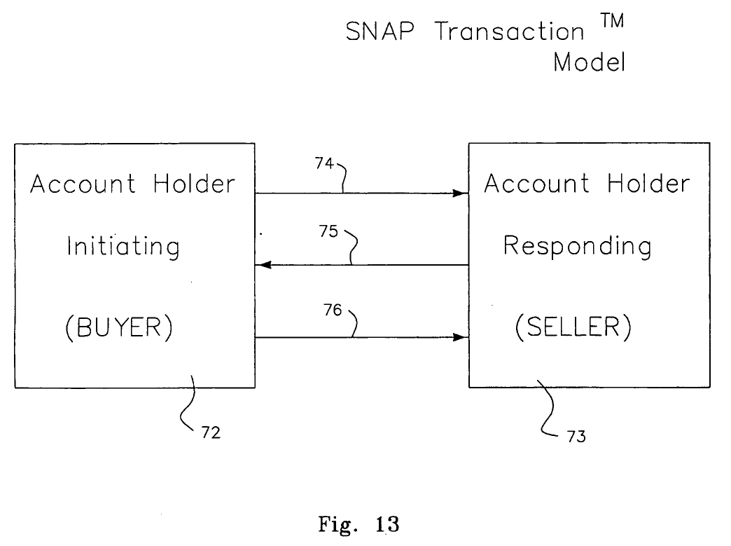

With reference to FIGS. 13, 14 and 15 a commercial transaction system 70 according to a further embodiment of the invention will now be described wherein the supporting financial intermediaries or institutions are introduced for the purpose of securing, holding and guaranteeing the sufficiency of funds for at least some transactions in which account holders/users enter into. In some jurisdictions such intermediaries are known as approved deposit-taking institutions (APIs) or deposit takers. Frequently such institutions or intermediaries are banks having the appropriate authority to hold funds on behalf of clients and clear such funds through other like-authorised intermediaries including, where necessary, appropriate Government authorities such as central banks and the like. In the description of the embodiment which follows the intermediary is termed a “deposit taker”. It will be noted that the deposit takers are no longer central or an intermediary to the transaction between a buyer and a seller but, instead, adopt a parallel or observation role.

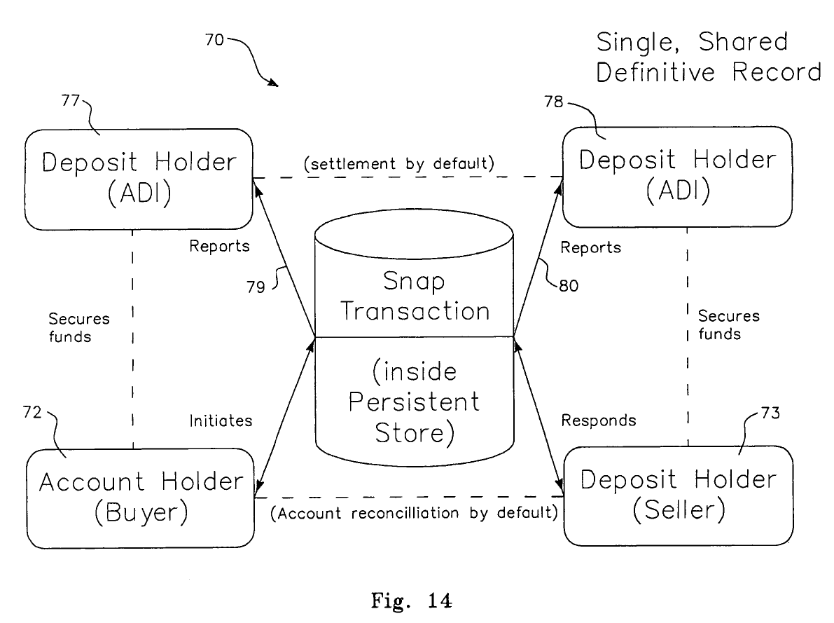

With particular reference to FIG. 14 the commercial transaction system 70 comprises a unitary store designated as and agreed by all users as the definitive record of all transactions conducted through the system 70, in this instance comprising persistent store 71.

In this instance a first account holder 72 acts in the capacity of a buyer whilst a second account holder 73 acts in the capacity of a seller. It is to be understood that any given account holder 72, 73 at any given time may act as either a buyer or a seller and they are only characterized as such according to the nature of their role in the transaction they enter into.

In this embodiment, should for example, account holder 72 initiate a buy transaction from account holder 73 then, with particular reference to FIG. 13, three distinct and separate groups of information will pass between account holder 72 and account holder 73 by way of persistent store 71. Again, it should be understood that information in the form of data does not flow contiguously from one account holder to another. The characteristic of the present system 70 utilising persistent store 71 is that the first information grouping comprising subscription step 74 is implemented as causing information relating to a subscription transaction to be set in persistent store 71. Account holder 73, being the intended recipient of the subscription information, is thereby given access to the information in the persistent store 71 pertaining to the subscription.

Having confirmed the subscription information at subscription step 74 residing in persistent store 71, account holder 73 may then respond to the existence of the information in system store 71 by entering into a presentation step 75 thereby accepting the subscription 74. Again, the presentation step 75 involves account holder 73, in its current capacity as seller, causing information to appear in persistent store 71 corresponding to an affirming presentation step 75. The account holder 73, in its current capacity as a buyer, will have access to that information in persistent store 71 and can ultimately affirm that presentation step 75 by entering into a settlement step 76.

Each of the steps 74, 75, 76 comprises an ACID step. Together they constitute a completed transaction between account holder 72 acting as a buyer and account holder 73 acting as a seller. The entire record of the completed transaction resides in persistent store 71 as an agreed definitive record of the steps 74, 75, 76 with the result that there is no necessity for either account holder 72 or account holder 73 to retain a separate record elsewhere.

In practice, and with reference to FIG. 14, where a transaction or series of transactions involves the transfer of currency from one account holder to another it will frequently be the case that each account holder will have at its disposal a financial institution acting as a holder of funds and otherwise frequently acting, in effect, as a guarantor of ability to settle fund amounts up to a predetermined sum. In this instance account holder 72 retains deposit holder 77 in this capacity whilst account holder 73 retains deposit taker 74 in a corresponding capacity. As will be observed from FIG. 14 the transaction represented by the steps 74, 75, 76 of FIG. 13 proceeds between account holder 72 and account holder 73 effectively independent of the existence of deposit takers 77, 78 with both account holders being bound by the record contained in persistent store 71. However, in this instance commercial transaction system 70 makes available relevant information within persistent store 71 relevant to the transaction of FIG. 13 to the respective deposit takers 77, 78 whereby, as appropriate, they can update their respective records.

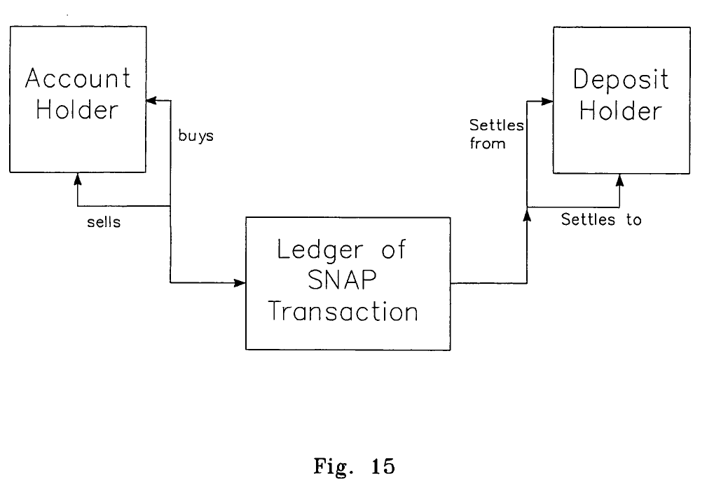

FIG. 15 illustrates the access that deposit takers 77, 78 have to those portions of the record contained in persistent store 71 relating to the transaction and relevant to its capacity as guarantor in respect of funds available to account holder 72. A corresponding arrangement applies in respect of account holder 73 and deposit holder 78 and also using the same data record contained in persistent store 71.

With reference to FIG. 9 certain kinds of transactions involving payment of moneys between parties can be tagged by tag 81 whereby the paying party has the value of a particular transaction effectively placed in escrow because the transaction has already been recorded in favour of the party to whom the money is to be paid. For example pending fulfillment by, for instance, a third party approved by the other two parties.

Transaction Security

Elements of security such as required for security policy 42 in respect of FIG. 5 will now be described with reference to FIG. 16.

On initiation of a link with a user as set out in Step A the system can initially query the user as in Step B for answers to trust test criteria as outlined in Step C, in this instance chosen from one or more of:

i. Computer ID

ii. Password and length of password

iii. Physiological ID

Following identification of the trust test criteria that the user wishes to elect the system then prompts for a transaction threshold value to be applied to that level of trust test criteria, in this instance, as outlined in Step D, selected from a choice of:

i. $100

ii. $500

iii. $1000

iv. other—specify

In this manner a user is made responsible for selecting trust test criteria and the transaction threshold values to which those particular trust test criteria will apply.

In more complex arrangements the user can specify different trust test criteria for different transaction threshold values or other actions.

This user defined levels of trust arrangement is in keeping with the nature of the transaction system described in previous embodiments wherein a flow-on consequence of users of the system accepting a single shared record as an agreed record of relevant transactions is that responsibility for those transactions resides squarely with the users. That is, once a transaction is entered into, the user is bound by the common record and has no recourse to a third party to step in and vary or set aside the transaction.

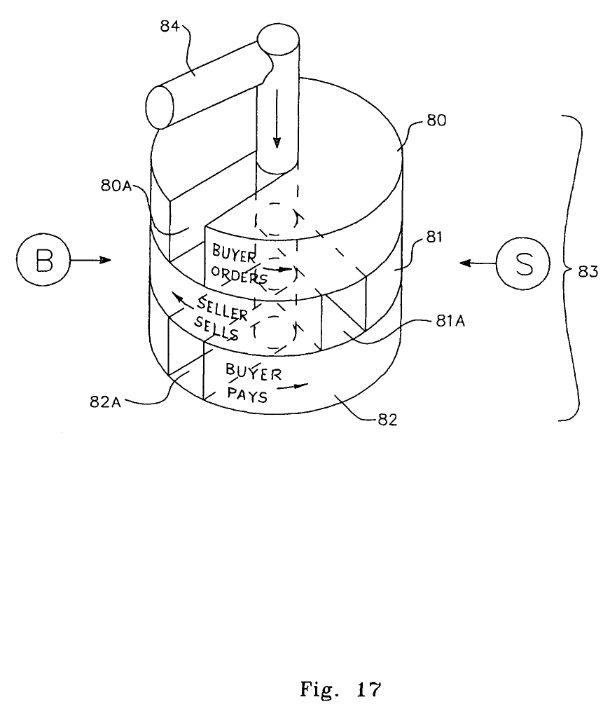

With reference to FIG. 17 the system of FIG. 1 is illustrated as a conceptual view.

In this instance a transaction is composed of an order or buy step 80 followed by a bill step 81 followed by a pay step 82. The buy step 80 is initiated by a user or party acting in the capacity of a buyer. The bill step 81 is activated or initiated by a user or party acting in the capacity of a seller as a response to the buying step. The entire transaction 83 comprising steps 80, 81, 82 must happen in serial fashion. This is illustrated conceptually by bar 84 which must pass through order slot 80A, then bill slot 81A followed by pay slot 82A for transaction 83 to be completed. For each step 80, 81, 82 to be completed a rotation of the relevant step component must take place (signifying completion of the step) in order to align the slot of that step with the slot of the next step so that bar 84 may pass through to the next step.

In this arrangement the later steps cannot take place until the previous step has been completed.

In a typical transaction a user will log on according to current security level. The user then creates and customizes a new level of security according to criteria set by that user. The user then applies that level of security to one or more activities including but not limited to authorizing transactions of specific levels of value.

The system allows the integration of deposit taking, order subscription, bill presentment, payment settlement, order fulfillment and accounting into a single, open participation system.

Any financial institution can participate as a deposit taker provided they have jurisdictional authority and agree to appropriate terms and conditions.

Any entity can participate as a buyer provided they agree to the appropriate terms and conditions. Any entity can participate as a seller.

It is possible for an entity to participate simultaneously as a buyer and as a seller.

Transactions are conducted not by transmission, but by updating the relevant portion of a single shared record.

It is to be emphasized that the system is designed to engender trust. Hence, a buyer always initiates a sale by making an order. A seller can only respond. A seller cannot initiate a transaction. The seller is empowered only to offer a commodity such as a product or service.

Summary

Some characteristics of the system according to one or more of the previously described embodiments include the following:

i. The system includes user defined levels of trust.

ii. All actions on money within the system are implemented as transfers. It follows, in this instance, that there is only one transfer model for transfers.

iii. Money or other commodity is preserved during each and every transfer.

iv. Access to the shared record of a transaction is selective according to inter alia, the capacity in which a given party is involved in any given transaction.

Disintermediation

v. Third parties such as financial institutions, whilst, in some embodiments, performing an important function in terms of guarantee of funds, are, nonetheless, not directly in the link between a first user and a second user of the system. Third parties such as financial institutions effectively adopt an observing or auditing role rather than being directly involved in a serial link between a first user and a second user. It follows that, in at least some embodiments, a transaction, for example, can be settled instantaneously rather than in the case (e.g. cheque transaction) where a bank or other financial institution is involved and through which clearing must take place resulting, typically in overnight delays in recording and/or settling such transactions. In this role, the financial institution or bank is not involved in intermediation.

The financial institution agrees to be bound by the transaction but acts as an observer—merely receives updates on the account situation.

### EXAMPLE 1

A commercial transaction system in accordance with one or more of the previously described embodiments will now be described with reference to the appendices wherein the exemplary system is entitled the “Thiri Internet Payment System” or “TIPS” for short.

Appendix A is entitled “UML Use Cases for Core System Functionality of the Thiri Internet Payment System”.

Appendix B is entitled “Core Requirements for TIPS” and comprises a specification in respect of which the system of Appendix A complies.

The above describes only some embodiments of the present invention and modifications, obvious to those skilled in the art, can be made thereto without departing from the scope and spirit of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A real-time transaction system to which a plurality of parties can subscribe; said system including a persistent store which contains a record of any given transaction between two or more of said parties; said record being a shared record of said transaction.

2. The transaction system of claim 1 wherein said shared record, by agreement of those of said parties who are subscribers to said system, is a definitive record of said transaction.

3. The system of claim 1 or claim 2 wherein said transaction entails a purchase.

4. The system of claim 1 or claim 2 wherein said transaction entails a sale.

5. The system of any one of claims 1 to 4 wherein said transaction comprises an ACID transaction.

6. The system of any one of claims 1 to 5 wherein each of said parties is characterized by a transaction.

7. The system of claim 6 wherein said party is characterized by said transaction based on their role of said transaction.

8. The system of claim 7 wherein said party is characterized as a buyer when the role of said party is as a buyer.

9. The system of claim 7 wherein said party is characterized as a seller when the role of said party is as a seller.

10. The system of any one of claims 1 to 9 wherein said record is protected by a security regime.

11. The system of claim 10 wherein said security regime is determined by a user of said system.

12. The system of claim 11 wherein each said security level is set by reference to the nature of a connection established by an individual one of said parties for and only for a particular transaction.

13. The system of any previous claim wherein said shared record can be accessed by each of said parties.

14. The system of claim 13 wherein each said party has access to only a part of said shared record.

15. The system of claim 14 wherein that part of said record to which a party has access is determined by the capacity in which said party acted in respect of data contained in said record.

16. A commercial transaction system to which a plurality of users can subscribe; said users agreeing to adopt a single common record as a definitive record of any given transaction between two or more of said users.

17. A method of determining security levels for parties to a transaction system; said transaction system being of the type to which a plurality of said parties can subscribe; said method comprising setting one or more security levels for an activity based on information derived from said party.

18. A real-time transaction system to which a plurality of parties can subscribe; said system including a persistent store which contains a single record of each and every transaction between two or more of said parties; said record being a shared record of said transaction.

19. The transaction system of claim 18 wherein said shared record, by agreement of those of said parties who are subscribers to said system, is a definitive record of said transaction between any said users so transacting.

20. The system of claim 18 or claim 19 wherein said shared record can be accessed by each of said parties.

21. The system of claim 20 wherein each said party has access to only a part of said shared record.

22. The system of claim 21 wherein that part of said record to which a party has access is determined by the capacity in which said party acted in respect of data contained in said record.

23. The system of claim 18 or claim 19 wherein each said transaction comprises a plurality of steps; said system integrating said plurality of steps.

24. The system of any one of claims 18 to 23 wherein said plurality of steps includes steps selected from deposit taking, ordering, billing and payment.

25. The system of any one of claims 18 to 24 wherein each step of said transaction comprises an ACID transaction.

26. The system of any one of claims 18 to 24 wherein each step of said transaction is Secure, Non-repudiable, Authenticated and Persistent.

27. The system of any one of claims 18 to 26 wherein said parties conclude said steps of said transactions by interacting directly with said record of said transaction; and wherein said interacting does not require said parties to cause the transmission of data to other parties.

28. The system of claims 18 to 27 wherein said transaction entails a purchase.

29. The system of claims 18 to 28 wherein said transaction entails a sale.

30. The system of any one of claims 18 to 29 wherein the role of each of said parties in any given said transaction is determined by their action within said transaction.

31. The system of claim 30 wherein said role of said party in any given said transaction is characterized as a buyer when said party acts as a buyer in said transaction.

32. The system of claim 31 wherein said role of said party in any given said transaction is characterized as a seller when said party acts as a seller.

33. A real-time transaction system to which a plurality of parties can subscribe; said system including a persistent store which contains a record of any given transaction between two or more of said parties; each of said parties being characterized by said system based on their role in said any given transaction.

34. The system of claim 33 wherein said record is a shared record of said transaction.

35. The transaction system of claim 33 or claim 34 wherein said shared record, by agreement of those of said parties who are subscribers to said system, is a definitive record of said transaction.

36. The system of claim 33 or claim 34 or claim 35 wherein said transaction entails a purchase.

37. The system of claim 33 or claim 34 or claim 35 wherein said transaction entails a sale.

38. The system of any one of claims 33 to 37 wherein said transaction comprises an ACID transaction.

39. The system of any one of claims 33 to 38 wherein each of said parties is characterized by a transaction.

40. The system of claim 39 wherein said party is characterized as a buyer when the role of said party is as a buyer.

41. The system of claim 39 wherein said party is characterized as a seller when the role of said party is as a seller.

42. The system of any one of claims 33 to 41 wherein said record is protected by a security regime.

43. The system of claim 42 wherein said security regime is determined by a user of said system.

44. The system of claim 43 wherein each said security level is set by reference to the nature of a connection established by an individual one of said parties for and only for a particular transaction.

45. The system of any one of claims 33 to 44 wherein said shared record can be accessed by each of said parties.

46. The system of claim 45 wherein each said party has access to only a part of said shared record.

47. The system of claim 46 wherein that part of said record to which a party has access is determined by the capacity in which said party acted in respect of data contained in said record.

48. A commercial transaction system to which a plurality of users can subscribe; said users agreeing to adopt a single common record as a definitive record of any given transaction between two or more of said users.

49. A real-time transaction system to which a plurality of parties can subscribe; said system including a persistent store which contains a single record of each and every transaction between two or more of said parties; said record being a shared record of said transaction.

50. The transaction system of claim 49 wherein said shared record, by agreement of those of said parties who are subscribers to said system, is a definitive record of said transaction between any said users so transacting.

51. The system of claim 49 or claim 50 wherein said shared record can be accessed by each of said parties.

52. The system of claim 51 wherein each said party has access to only a part of said shared record.

53. The system of claim 52 wherein that part of said record to which a party has access is determined by the capacity in which said party acted in respect of data contained in said record.

54. The system of claim 52 or claim 53 wherein each said transaction comprises a plurality of steps; said system integrating said plurality of steps.

55. The system of any one of claims 49 to 54 wherein said plurality of steps includes steps selected from deposit taking, ordering, billing and payment.

56. The system of any one of claims 49 to 55 wherein each step of said transaction comprises an ACID transaction.

57. The system of any one of claims 49 to 56 wherein each step of said transaction is Secure, Non-repudiable, Authenticated and Persistent.

58. The system of any one of claims 49 to 57 wherein said parties conclude said steps of said transactions by interacting directly with said record of said transaction; and wherein said interacting does not require said parties to cause the transmission of data to other parties.

59. The system of claims 49 to 58 wherein said transaction entails a purchase.

60. The system of claims 49 to 59 wherein said transaction entails a sale.

61. The system of any one of claims 49 to 60 wherein the role of each of said parties in any given said transaction is determined by their action within said transaction.

62. The system of claim 61 wherein said role of said party in any given said transaction is characterized as a buyer when said party acts as a buyer in said transaction.

63. The system of claim 62 wherein said role of said party in any given said transaction is characterized as a seller when said party acts as a seller.

64. A method of determining security levels for parties to a transaction system; said transaction system being of the type to which a plurality of said parties can subscribe; said method comprising setting one or more security levels for an activity based on information derived from said party.

65. A real-time transaction system to which a plurality of parties can subscribe; said system incorporating the method of claim 64; said system including a persistent store which contains a record of any given transaction between two or more of said parties; said record being a shared record of said transaction.

66. The transaction system of claim 65 wherein said shared record, by agreement of those of said parties who are subscribers to said system, is a definitive record of said transaction.

67. The system of claim 65 or claim 66 wherein said transaction entails a purchase.

68. The system of claim 65 or claim 66 or claim 67 wherein said transaction entails a sale.

69. The system of any one of claims 65 to 68 wherein said transaction comprises an ACID transaction.

70. The system of any one of claims 65 to 69 wherein each of said parties is characterized by a transaction.

71. The system of claim 70 wherein said party is characterized by said transaction based on their role of said transaction.

72. The system of claim 71 wherein said party is characterized as a buyer when the role of said party is as a buyer.

73. The system of claim 72 wherein said party is characterized as a seller when the role of said party is as a seller.

74. The system of any one of claims 65 to 73 wherein said record is protected by a security regime.

75. The system of claim 74 wherein said security regime is determined by a user of said system.

76. The system of claim 75 wherein each said security level is set by reference to the nature of a connection established by an individual one of said parties for and only for a particular transaction.

77. The system of any one of claims 65 to 76 wherein said shared record can be accessed by each of said parties.

78. The system of claim 77 wherein each said party has access to only a part of said shared record.

79. The system of claim 78 wherein that part of said record to which a party has access is determined by the capacity in which said party acted in respect of data contained in said record.

80. A method of determining levels of authentication for parties to a transaction system; said transaction system being of the type to which a plurality of said parties can subscribe; said method comprising setting one or more security levels for an activity based on information derived from said party.

81. The method of claim 80 wherein said party creates one or more said levels of authentication.

82. The method of claims 80 or claim 81 wherein said party sets parameters for each said level of authentication

83. The method of any of claims 80 to 82 wherein said party applies said level of authentication to one or more activities to be conducted by said user within said transaction system.

84. The method of any of claims 80 to 83 wherein said party, after applying said level of authentication to said activity, may only thereafter conduct said activity when authenticated to said level of authentication.

85. The method of claim 84 wherein said user, having been authenticated to said level of authentication for any said activity, may thereafter apply a new said level of authentication to said level of activity; new said level of authentication being needed to conduct said activity thereafter; old said level of authentication being no longer able to grant said user access to said activity.

86. A real-time transaction system to which a plurality of parties can subscribe; said system including a persistent store which contains a record of any given transaction between two or more of said parties; said record being a shared record of said transaction; said transaction comprising a plurality of steps; said system integrating said plurality of steps.

87. The system of claim 86 wherein said plurality of steps includes steps selected from deposit taking, ordering, billing, payment and settlement.

88. The transaction system of claim 86 or claim 87 wherein said shared record, by agreement of those of said parties who are subscribers to said system, is a definitive record of said transaction.

89. The system of claim 86 or claim 87 or claim 88 wherein said transaction entails a purchase.

90. The system of claim 86 or claim 87 or claim 88 wherein said transaction entails a sale.

91. The system of any one of claims 86 to 90 wherein said transaction comprises an ACID transaction.

92. The system of any one of claims 86 to 90 wherein each of said parties is characterized by a transaction.

93. The system of claim 92 wherein said party is characterized by said transaction based on their role of said transaction.

94. The system of claim 93 wherein said party is characterized as a buyer when the role of said party is as a buyer.

95. The system of claim 94 wherein said party is characterized as a seller when the role of said party is as a seller.

96. The system of any one of claims 86 to 95 wherein said record is protected by a security regime.

97. The system of claim 96 wherein said security regime is determined by a user of said system.

98. The system of claim 97 wherein each said security level is set by reference to the nature of a connection established by an individual one of said parties for and only for a particular transaction.

99. The system of any one of claims 86 to 98 wherein said shared record can be accessed by each of said parties.

100. The system of claim 99 wherein each said party has access to only a part of said shared record.

101. The system of claim 100 wherein that part of said record to which a party has access is determined by the capacity in which said party acted in respect of data contained in said record.

102. The system of any one of claim 86 to 101 wherein said transaction is a commercial transaction.

103. A real-time transaction system to which a plurality of parties can subscribe; said system including a persistent store which contains a single record of each and every given transaction between two or more of said parties; said record being a shared record of said transaction.

104. The transaction system of claim 103 wherein said shared record, by agreement of those of said parties who are subscribers to said system, is a definitive record of said transaction between any said users so transacting.

105. The system of claim 103 or claim 104 wherein said shared record can be accessed by each of said parties.

106. The system of claim 105 wherein each said party has access to only a part of said shared record.

107. The system of claim 106 wherein that part of said record to which a party has access is determined by the capacity in which said party acted in respect of data contained in said record.

108. The system of claim 103 or claim 104 wherein each said transaction comprises a plurality of steps; said system integrating said plurality of steps.

109. The system of any one of claims 103 to 108 wherein said plurality of steps includes steps selected from deposit taking, ordering, billing and payment.

110. The system of any one of claims 103 to 109 wherein each step of said transaction comprises an ACID transaction.

111. The system of any one of claims 103 to 110 wherein each step of said transaction is Secure, Non-repudiable, Authenticated and Persistent.

112. The system of any one of claims 103 to 111 wherein said parties conclude said steps of said transactions by interacting directly with said record of said transaction; wherein said interaction does not require said parties transmitting data to other parties.

113. The system of claims 103 to 112 wherein said transaction entails a purchase.

114. The system of claims 103 to 113 wherein said transaction entails a sale.

115. The system of any one of claims 103 to 114 wherein the role of each of said parties in any given said transaction is determined by their action within said transaction.

116. The system of claim 115 wherein said role of said party in any given said transaction is characterized as a buyer when said party acts as a buyer in said transaction.

117. The system of claim 115 wherein said role of said party in any given said transaction is characterized as a seller when said party acts as a seller.
